(19) United States
(12) Patent Application Publication
(10) Pub. No.: US 2017/0291278 A1
(43) Pub. Date: Oct. 12, 2017

(54) POLISHING PAD-MEASURING APPARATUS AND CHEMICAL MECHANICAL POLISHING FACILITY USING THE SAME

(71) Applicant: Samsung Electronics Co., Ltd., Suwon-si (KR)

(72) Inventors: Kwangsung LEE, Yongin-si (KR); Ki-Roo Shin, Suwon-si (KR); Kwangchun Kim, Hwaseong-si (KR); Yeonjun Lim, Anyang-si (KR); Junghun Cho, Hwaseong-si (KR); Sangkyeong Han, Seongnam-si (KR)

(73) Assignee: Samsung Electronics Co., Ltd., Suwon-si (KR)

(21) Appl. No.: 15/413,845

(22) Filed: Jan. 24, 2017

(30) Foreign Application Priority Data
Apr. 6, 2016 (KR) 10-2016-0042447

(51) Int. Cl. B24B 49/12; G01B 11/24; G01B 11/22; B24B 37/04; B24B 53/017

(52) U.S. Cl. CPC B24B 49/12; B24B 37/04; B24B 53/017; G01B 11/22; G01B 11/24

(57) ABSTRACT

Example embodiments of the inventive concepts provide a polishing pad-measuring apparatus and a chemical mechanical polishing facility using the same. The polishing pad-measuring apparatus includes a foreign material-removing part for removing a foreign material disposed in grooves extending from one surface of a polishing pad toward another surface, opposite to the one surface, of the polishing pad, and a distance measuring part for measuring depths of the grooves from which the foreign material is removed.

### CROSS-REFERENCE TO RELATED APPLICATION

This U.S. non-provisional patent application claims priority under 35 U.S.C. §119 to Korean Patent Application No. 10-2016-0042447, filed on Apr. 6, 2016, in the Korean Intellectual Property Office, the disclosure of which is hereby incorporated by reference in its entirety.

### BACKGROUND

Some example embodiments of the inventive concepts relate to a polishing pad-measuring apparatus and/or a chemical mechanical polishing facility using the same and, more particularly, to a polishing pad-measuring apparatus capable of accurately measuring a profile of a polishing pad and a chemical mechanical polishing facility using the same.

In general, a semiconductor device may be manufactured to include a plurality of stacked circuit patterns formed by repeatedly performing photolithography processes, etching processes, ion implantation processes, diffusion processes, deposition processes, and other unit processes on a wafer.

As semiconductor devices have been highly integrated, widths and spaces of circuit patterns have been reduced and accurate overlay between lower and upper circuit patterns have been demanded. However, different materials may be deposited or grown in a process of forming a circuit pattern in each layer, and thus a surface of a wafer may have a non-uniform shape. This surface may cause a process defect, e.g. an alignment error in a photolithography process. Thus, a process of planarizing a target surface may be performed between unit processes of manufacturing a semiconductor device.

There are various techniques capable of planarizing a target surface of a wafer. A chemical mechanical polishing (CMP) technique among these techniques is widely used.

### SUMMARY

Some example embodiments of the inventive concepts may provide a polishing pad-measuring apparatus capable of accurately measuring a profile of a polishing pad and a chemical mechanical polishing facility capable of planarizing a surface of a wafer using the measured profile of the polishing pad.

Some example embodiments of the inventive concepts may also provide a polishing pad-measuring apparatus capable of accurately measuring a lifetime of a polishing pad and a chemical mechanical polishing facility using the same.

In one example embodiment, a polishing pad-measuring apparatus configured to measure a profile of a polishing pad polishing a wafer may include a foreign material-removing part configured to remove a foreign material disposed in grooves extending from a first surface of the polishing pad toward a second surface, opposite to the first surface, of the polishing pad, and a distance measuring part configured to measure depths of the grooves from which the foreign material-removing part has removed foreign material.

In one example embodiment, a chemical mechanical polishing facility may include a polishing station including a plurality of platens and polishing pads respectively disposed on the platens, a rotatable polishing head assembly disposed on the polishing station, the polishing head assembly including a plurality of polishing heads, the plurality of polishing heads configured to picking up a wafer, and a polishing pad-measuring apparatus coupled to the polishing head assembly. Each of the polishing pads may have a plurality of grooves extending from one surface toward another surface opposite to the one surface. The polishing pad-measuring apparatus may include a foreign material-removing part configured to remove at least one foreign material disposed in the grooves, and a distance measuring part for measuring depths of the grooves from which the foreign material-removing part has removed foreign material.

In one example embodiment, a chemical mechanical polishing facility may include a polishing station including a pad conditioner configured to condition a polishing pad, and a polishing pad measuring apparatus including a foreign material-removing part and a distance measuring part. The foreign material-removing part may be configured to remove at least one foreign material disposed in a plurality of grooves of the polishing pad, and the distance measuring part may be configured to measure depths of the grooves of the polishing pad from which the foreign material-removing part has removed foreign material. The chemical mechanical polishing facility may include a controller configured to control the pad conditioner based on output from the distance measuring part.

### BRIEF DESCRIPTION OF THE DRAWINGS

The inventive concepts will become more apparent in view of the attached drawings and accompanying detailed description.

FIG. 1 is a block diagram illustrating a chemical mechanical polishing facility according to some embodiments of the inventive concepts.

FIG. 2 is a plan view illustrating the chemical mechanical polishing facility of FIG. 1.

FIG. 3 is a plan view illustrating a polishing station of FIG. 2.

FIG. 4 is a back view illustrating a polishing head assembly of FIG. 2.

FIG. 5 is a perspective view illustrating a polishing pad-measuring apparatus of FIG. 2.

FIGS. 6 and 7 are cross-sectional views illustrating a method of measuring a profile of a polishing pad by the polishing pad-measuring apparatus of FIG. 5, according to some embodiments of the inventive concepts.

FIGS. 8 and 9 are graphs illustrating the profile of the polishing pad which is measured by the polishing pad-measuring apparatus of FIG. 5.

FIGS. 10A to 10D are plan views illustrating a method of operating the chemical mechanical polishing facility of FIG. 2.

FIGS. 11A and 11B are plan views illustrating a method of measuring a profile of a polishing pad by the polishing pad-measuring apparatus of FIG. 5, according to some embodiments of the inventive concepts.

FIG. 12 is a cross-sectional view illustrating a polishing pad-measuring apparatus according to some embodiments of the inventive concepts.

FIG. 13 is a perspective view illustrating a polishing pad-measuring apparatus according to some embodiments of the inventive concepts.

FIG. 14 is a perspective view illustrating a polishing pad-measuring apparatus according to some embodiments of the inventive concepts.

FIG. 15 is a plan view illustrating a method of measuring a profile of a polishing pad by the polishing pad-measuring apparatus of FIG. 14, according to some embodiments of the inventive concepts.

### DETAILED DESCRIPTION

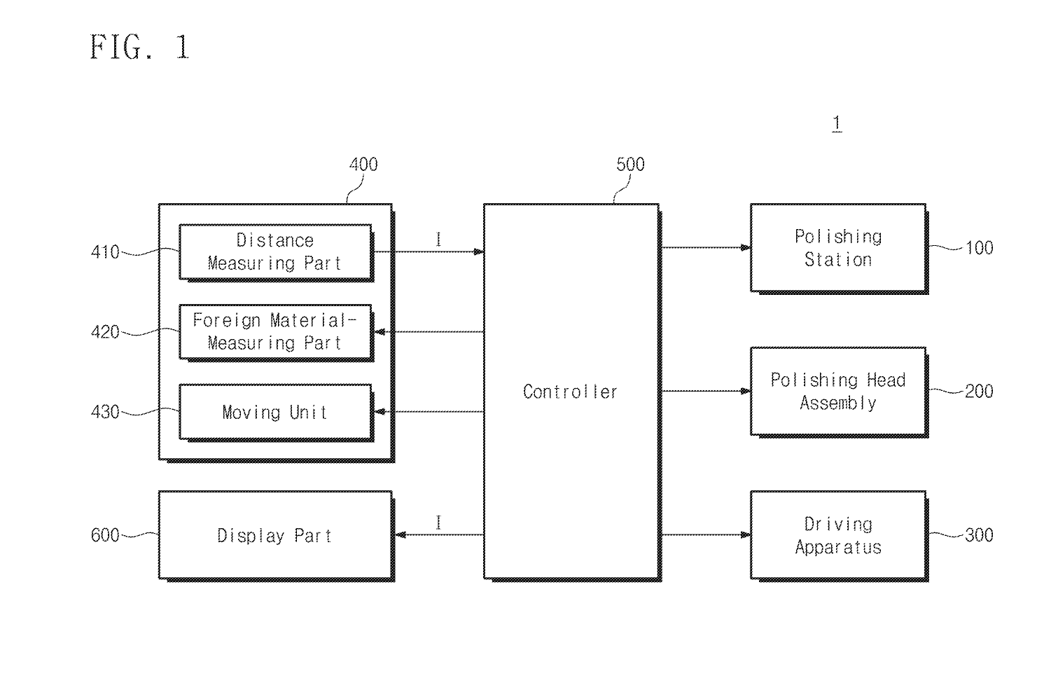

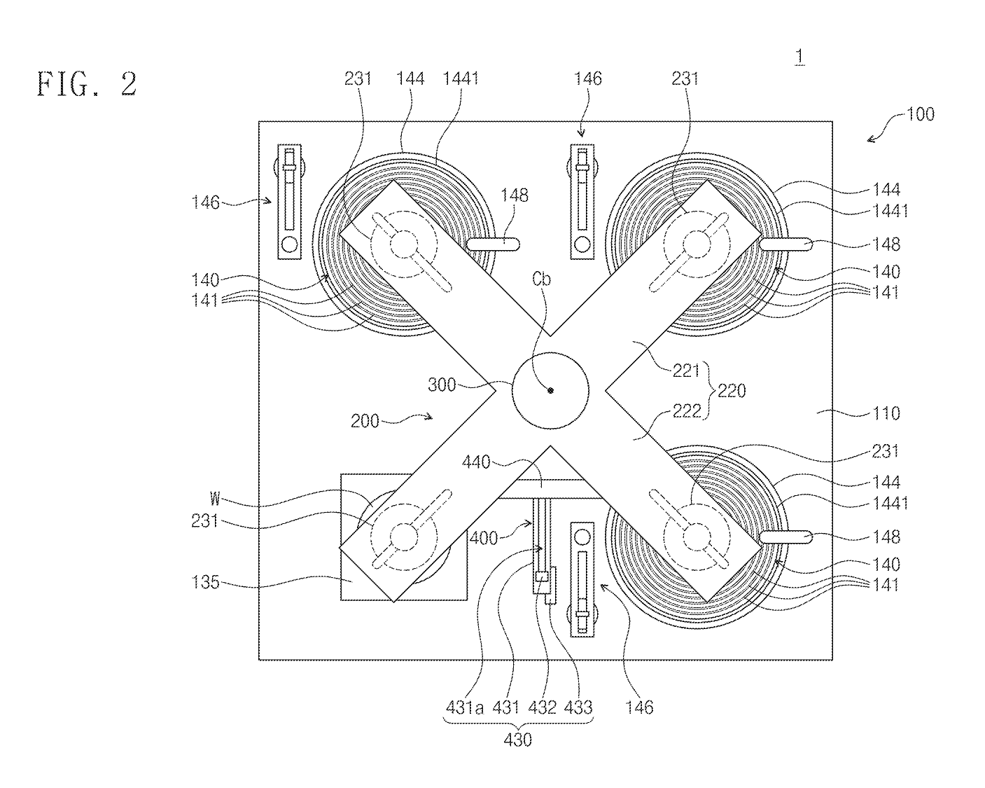

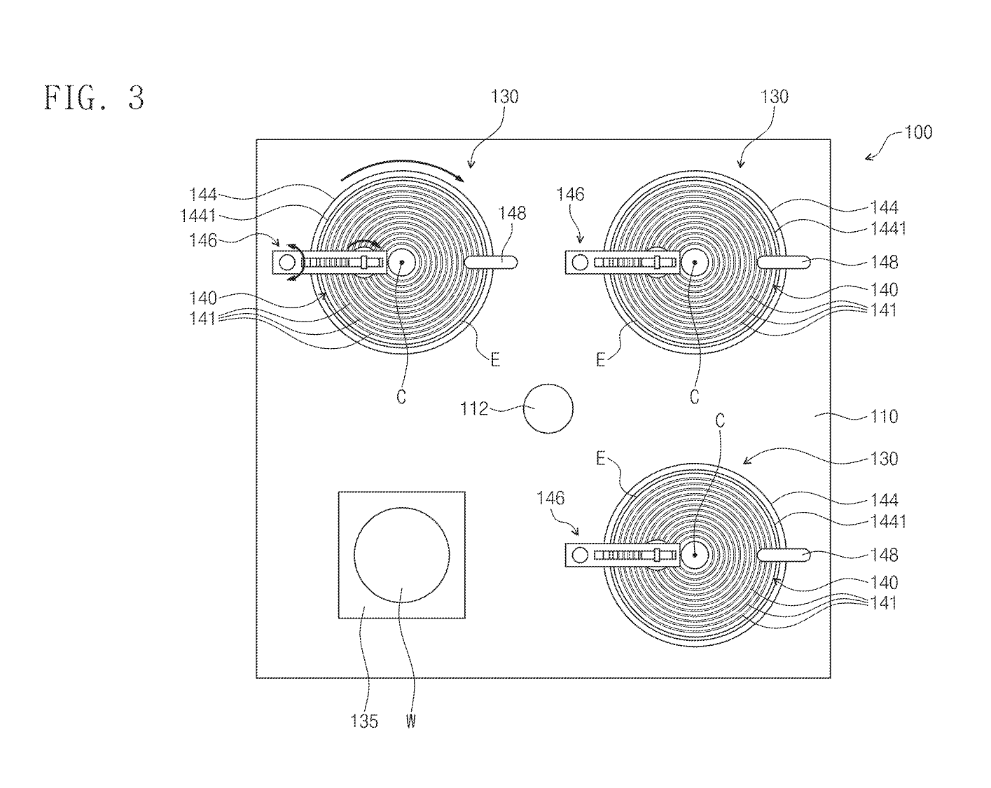

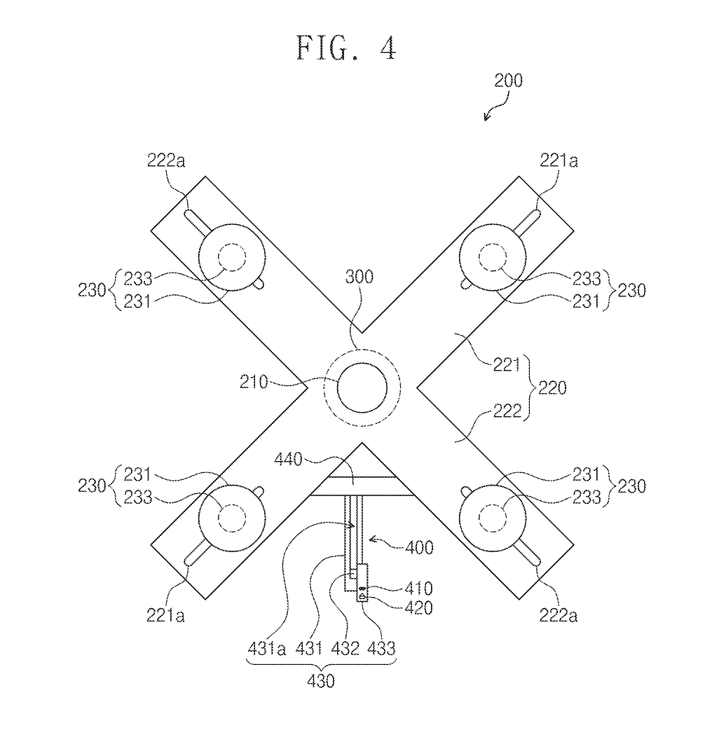

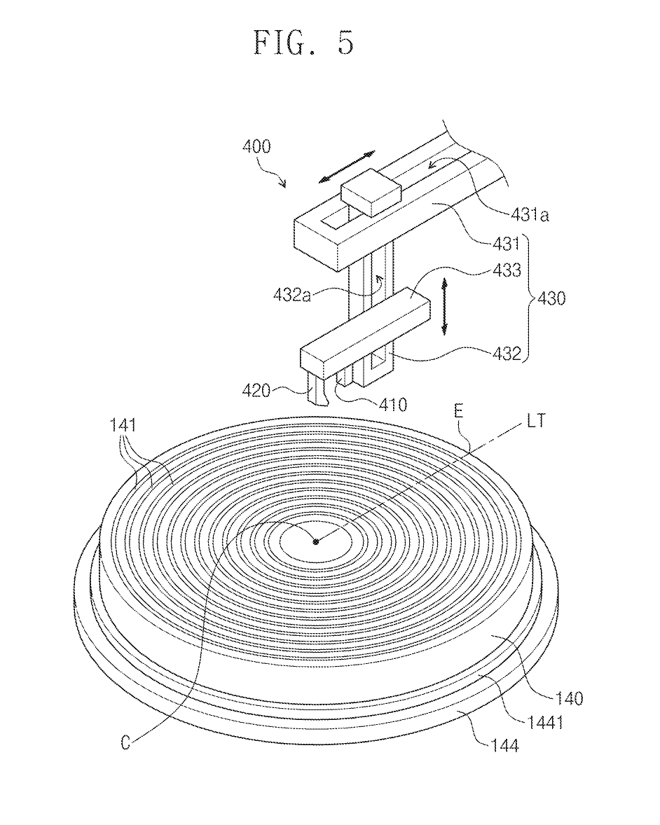

FIG. 1 is a block diagram illustrating a chemical mechanical polishing facility according to some embodiments of the inventive concepts. FIG. 2 is a plan view illustrating the chemical mechanical polishing facility of FIG. 1. FIG. 3 is a plan view illustrating a polishing station of FIG. 2. FIG. 4 is a back view illustrating a polishing head assembly of FIG. 2. FIG. 5 is a perspective view illustrating a polishing pad-measuring apparatus of FIG. 2.

Referring to FIGS. 1 to 5, a polishing pad-measuring apparatus 400 according to some embodiments may be provided, and a chemical mechanical polishing facility 1 including the polishing pad-measuring apparatus 400 may be provided. The chemical mechanical polishing facility 1 may perform a polishing process. The chemical mechanical polishing facility 1 may perform the polishing process on a wafer W by using the polishing pad-measuring apparatus 400. For example, the chemical mechanical polishing facility 1 may be used to polish an insulating layer or a conductive layer of a semiconductor device. However, some example embodiments of the inventive concepts are not limited thereto.

The chemical mechanical polishing facility 1 may include a polishing station 100, a polishing head assembly 200, a driving apparatus 300, the polishing pad-measuring apparatus 400, a controller 500, and a display part 600.

The polishing station 100 may include a lower body 110, a loading/unloading part 135, polishing parts 130, and a lower post 112.

The lower body 110 may support the loading/unloading part 135, the polishing parts 130, and the lower post 112. In other words, the loading/unloading part 135, the polishing parts 130, and the lower post 112 may be disposed on a top surface of the lower body 110. The lower post 112 may have a cylindrical shape extending upward from a center of the lower body 110. In certain some example embodiments, the lower body 110 may have a square pillar shape. However, some example embodiments of the inventive concepts are not limited thereto.

The loading/unloading part 135 may provide a space in which a wafer W is loaded and/or unloaded. In other words, a wafer W on which a pre-process is performed may be loaded into the chemical mechanical polishing facility 1 through the loading/unloading part 135, and a wafer W on which the polishing process is performed may be unloaded from the chemical mechanical polishing facility 1 through the loading/unloading part 135.

Each of the polishing parts 130 may polish a polishing target surface of a wafer W in the polishing process. The polishing parts 130 and the loading/unloading part 135 may be arranged at intervals of specific angles with respect to the center of the lower body 110. For example, three polishing parts 130 and the loading/unloading part 135 may be arranged at about 90 degrees with respect to the center of the lower body 110.

Each of the polishing parts 130 may include a platen 144, a pad conditioner 146, a slurry supply pipe 148, and a polishing pad 140.

The platen 144 may be disposed on the top surface of the lower body 110. The platen 144 may be rotatable on a rotation axis perpendicular to the top surface of the lower body 110. For example, the platen 144 may be connected to a rotation motor (not shown) disposed in the lower body 110. Thus, the platen 144 may rotate clockwise and/or counterclockwise at a speed of 30 revolutions per minute (rpm) to 200 rpm. In some example embodiments, the platen 144 may have a circular plate shape like a wafer W. However, some example embodiments of the inventive concepts are not limited thereto. In addition, the platen 144 may include a bump 1441 surrounding a circumference of the polishing pad 140. The bump 1441 may prevent a wafer W from escaping from the platen 144 by the rotation of the platen 144.

Referring to FIG. 5, the polishing pad 140 may be disposed on the platen 144. The circumference of the polishing pad 140 may be surrounded by the bump 1441. The polishing pad 140 may be rotated by the platen 144 during the polishing process. Thus, the polishing pad 140 may become in direct contact with the polishing target surface of a wafer W to physically polish the polishing target surface. A diameter of the polishing pad 140 may be about two or more times greater than a diameter of a wafer W. However, some example embodiments of the inventive concepts are not limited thereto.

The polishing pad 140 may include a porous material (e.g., polyurethane) having a large number of micro-spaces. The micro-spaces of the polishing pad 140 may receive slurry for chemically mechanically polishing the polishing target surface of a wafer W.

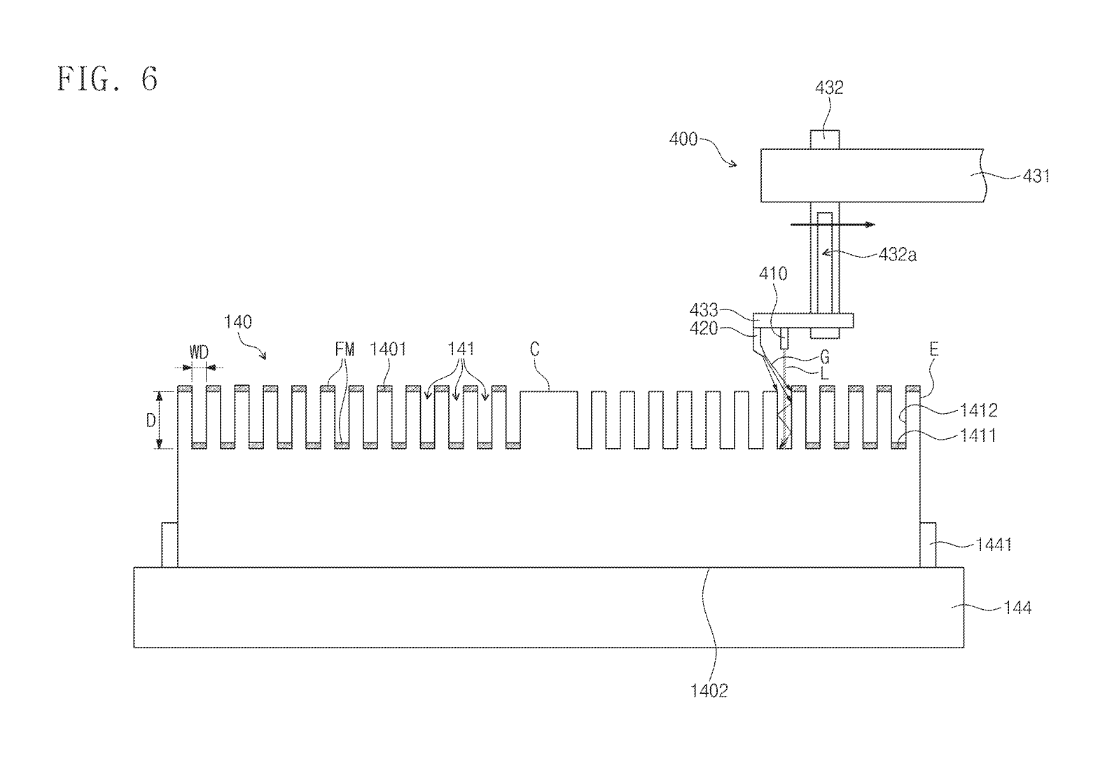

The polishing pad 140 may include a plurality of grooves 141. The grooves 141 may be arranged at equal intervals from a center C of the polishing pad 140 to an edge E of the polishing pad 140. The grooves 141 may have circular closed-loop shapes which use the center C of the polishing pad 140 as centers. In other words, the grooves 141 may be concentric circles. The grooves 141 will be described later in detail with reference to FIG. 6.

The pad conditioner 146 may be adjacent to the platen 144. The pad conditioner 146 may maintain a state of the polishing pad 140 to effectively polish the polishing target surface of a wafer W. For example, the pad conditioner 146 may become in contact with a polishing surface of the polishing pad 140 to substantially planarize the polishing surface of the polishing pad 140.

The slurry supply pipe 148 may be adjacent o the platen 144. The slurry supply pipe 148 may provide the slurry onto the polishing pad 140. At least one of the slurry supply pipes 148 of the polishing parts 130 may provide another slurry to the polishing pad 140. Here, the slurry may include a reactant deionized water for oxidation polishing), wear particles silicon dioxide for oxidation polishing), and a chemical reaction catalyst (e.g., potassium hydroxide for oxidation polishing).

The polishing head assembly 200 may be disposed over the polishing station 100. The polishing head assembly 200 may include an upper body 220, an upper post 210, and wafer pickup parts 230.

The upper body 220 may be disposed over the lower body 110. In some example embodiments, the upper body 220 may have a shape in which first and second bar parts 221 and 222 intersect each other. For example, the upper body 220 may have a cross shape or an X-shape. However, some example embodiments of the inventive concepts are not limited thereto. The first and second bar parts 221 and 222 may be long relative to the diameter of a wafer. The first and second bar parts 221 and 222 may have slots 221a and 222a provided adjacent to ends of the first and second bar parts 221 and 222. The slots 221 and 222a may be formed lengthwise in longitudinal directions of the first and second bar parts 221 and 222.

The upper post 210 may be disposed at a center Cb of the upper body 220. In other words, the upper post 210 may be disposed at a crossing portion of the first and second bar parts 221 and 222. The upper body 220 may be rotated clockwise and/or counterclockwise on an imaginary rotation axis by the driving apparatus 300. The imaginary rotation axis may pass through a center Cb of the upper body 220.

The wafer pickup parts 230 may be disposed at the upper body 220. For example, the wafer pickup parts 230 may be disposed adjacent to the ends of the first and second bar parts 221 and 222, respectively. Each of the wafer pickup parts 230 may be slidingly movable along each of the slots 221a and 222a. In some example embodiments, four wafer pickup parts 230 may be provided. When one of the four wafer pickup parts 230 is disposed on the loading/unloading part 135, the others of the four wafer pickup parts 230 may be disposed on the polishing parts 130, respectively.

Each of the wafer pickup parts 230 may include a polishing head 231 and a head driving motor 233.

The polishing head 231 may adsorb a wafer W by vacuum pressure in such a way that the polishing target surface of the wafer W faces the polishing pad 140. The polishing head 231 may be vertically movable by a head elevating unit (not shown). The polishing head 231 may descend toward the polishing pad 140 when the polishing process is performed. Thus, the wafer W adsorbed to the polishing head 231 may press the polishing pad 140.

The head driving motor 233 may provide power for rotating the polishing head 231 when the polishing process is performed. Thus, the polishing head 231 may be rotated clockwise and/or counterclockwise. In some example embodiments, the polishing head 231 may be rotated in the same direction as a rotation direction of the polishing pad 140. The head driving motor 233 and the polishing head 231 may be connected to each other by a driving shaft (not shown).

The polishing pad-measuring apparatus 400 may measure a profile of the polishing pad 140. The polishing pad-measuring apparatus 400 may include a distance measuring part 410, a foreign material-removing part 420, a moving unit 430, and a coupling member 440. The polishing pad-measuring apparatus 400 may be connected to the upper body 220 by the coupling member 440.

The coupling member 440 may be connected to the moving unit 430. The coupling member 440 may be coupled to the upper body 220. Thus, the coupling member 440 may connect the moving unit 430 to the upper body 220. In some example embodiments, one end of the coupling member 440 may be coupled to the first bar part 221, and another end of the coupling member 440 may be coupled to the second bar part 222. In other words, the coupling member 440 may intersect a space between the first and second bar parts 221 and 222 so as to be coupled to the first and second bar parts 221 and 222. Thus, the polishing pad-measuring apparatus 400 may be disposed in the space between the first and second bar parts 221 and 222. In other words, the polishing pad-measuring apparatus 400 may be disposed between a pair of the wafer pickup parts 230 adjacent to each other. The coupling member 440 may be connected to the moving unit 430 moving the distance measuring part 410 and the foreign material-removing part 420.

The moving unit 430 may move the distance measuring part 410 along an imaginary trajectory LT connecting the center C to the edge E of the polishing pad 140. The moving unit 430 may move the foreign material-removing part 420 together with the distance measuring part 410. In other words, the moving unit 430 may move the distance measuring part 410 and the foreign material-removing part 420 on one surface (Reference to 1401 in FIG. 6) of the polishing pad 140. The moving unit 430 may include a linear guide member 431, a linear moving member 432, and an elevating member 433.

The linear guide member 431 may be connected to the coupling member 440. For example, one end of the linear guide member 431 may be coupled to an intermediate region of the coupling member 440. The linear guide member 431 may be disposed in parallel to an imaginary linear trajectory LT connecting the center C and the edge E of the polishing pad 140. In some example embodiments, the linear guide member 431 may have a guide hole 431a. The guide hole 431a may be formed lengthwise in a longitudinal direction of the linear guide member 431. Alternatively, in certain embodiments, the linear guide member 431 may have guide rails (not shown) formed lengthwise in the longitudinal direction of the linear guide member 431.

The linear moving member 432 may be movable along the linear guide member 431 by a driving unit (not shown). Thus, the linear moving member 432 may be movable in parallel to the imaginary linear trajectory LT on the polishing pad 140. One end of the linear moving member 432 may pass through the guide hole 431a and may be supported by a top surface of the linear guide member 431. The linear moving member 432 may be parallel to a direction perpendicular to the one surface 1401. The linear moving member 432 may have a guide groove 432a. The guide groove 432a may be formed at one sidewall of the linear moving member 432. The guide groove 432a may be formed lengthwise in a longitudinal direction of the linear moving member 432.

The elevating member 433 may be movable along the guide groove 432a of the linear moving member by an elevating unit (not shown). Thus, the elevating member 433 may be movable in the direction perpendicular to the one surface 1401 on the polishing pad 140. The elevating member 433 may be connected to the distance measuring part 410 and the foreign material-removing part 420. For example, the distance measuring part 410 and the foreign material-removing part 420 may be connected to a bottom surface of the elevating member 433.

The foreign material-removing part 420 may remove a foreign material FM in the grooves 141 of the polishing pad 140. The foreign material-removing part 420 may be movable together with the distance measuring part 410 by the moving unit 430. Thus, the foreign material-removing part 420 may remove the foreign material FM in the grooves 141 disposed on the imaginary linear trajectory LT and/or the foreign material FM disposed on the one surface 1401. In some embodiments, the foreign material-removing part 420 may move along the imaginary linear trajectory LT or in parallel to the imaginary linear trajectory LT. The foreign material-removing part 420 will be described later in detail with reference to FIG. 6.

The distance measuring part 410 may measure a profile of the grooves 141 from which the foreign material FM is removed. The distance measuring part 410 may be reciprocally movable along the imaginary trajectory LT connecting the center C and the edge E of the polishing pad 140. According to some embodiments of the inventive concepts, the imaginary trajectory LT may be a line shape. Thus, the distance measuring part 410 may be linearly movable from the center C toward the edge E of the polishing pad 140. In addition, the distance measuring part 410 may be linearly movable from the edge E toward the center C of the polishing pad 140.

The distance measuring part 410 may include a laser sensor that can measure a distance in a state in which the distance measuring part 410 is not in contact with the polishing pad 140. However, embodiments of the inventive concepts are not limited thereto. The distance measuring part 410 will be described later in detail with reference to FIG. 6.

The controller 500 may control the polishing station 100, the polishing head assembly 200, the driving apparatus 300, and the polishing pad-measuring apparatus 400.

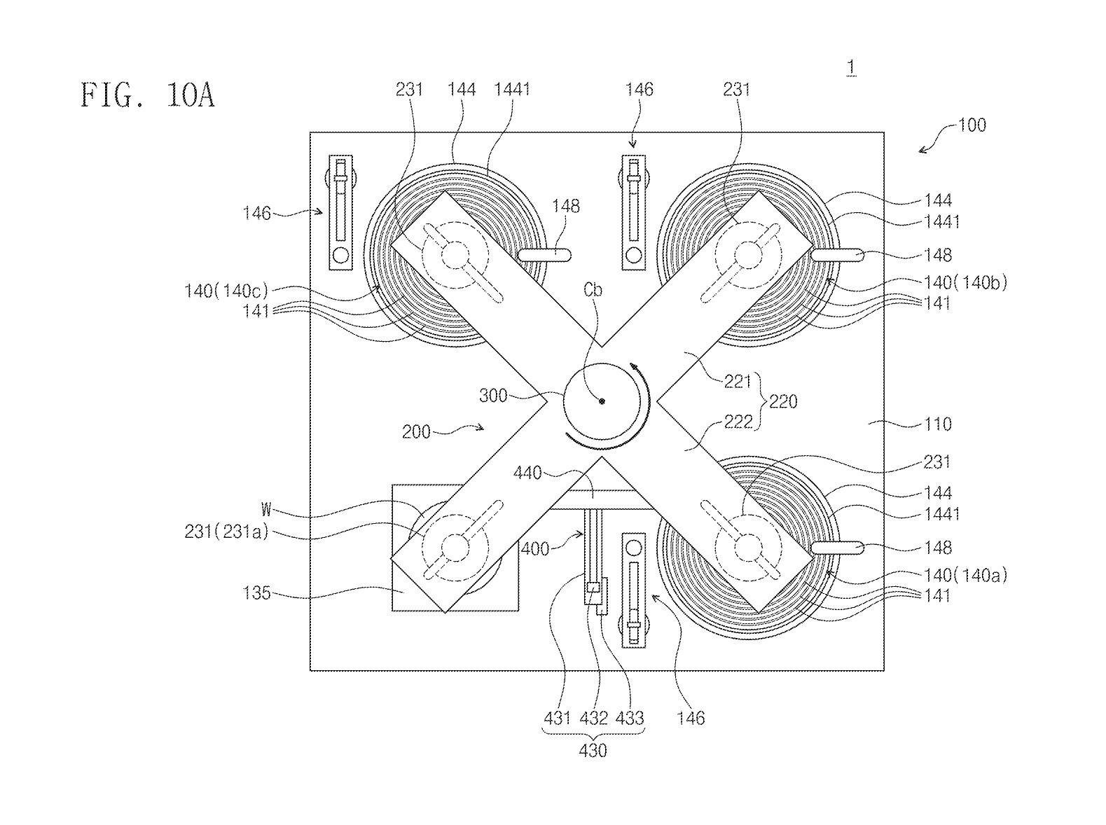

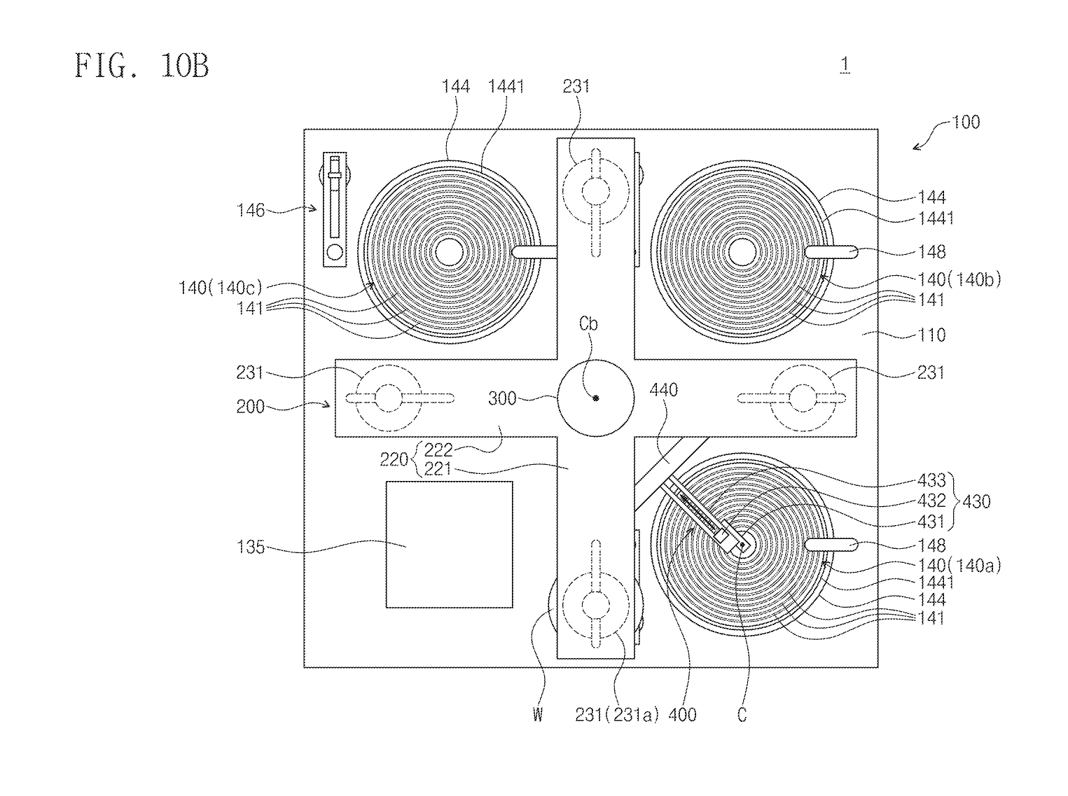

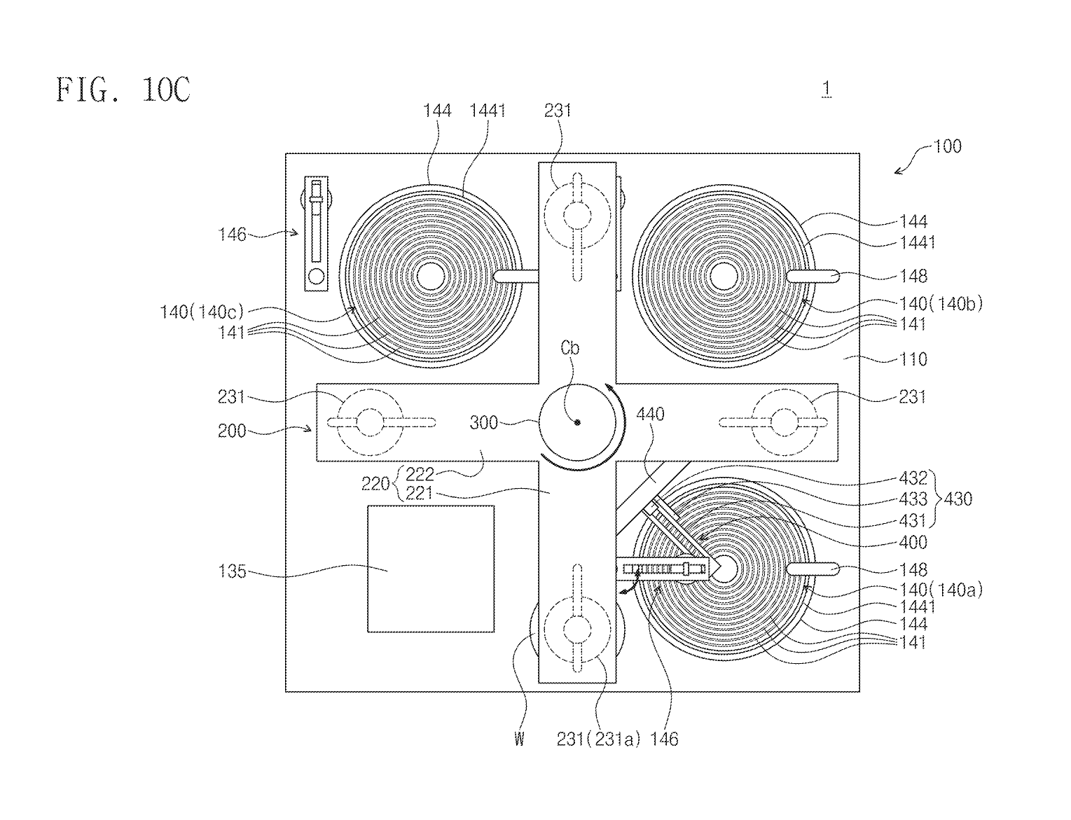

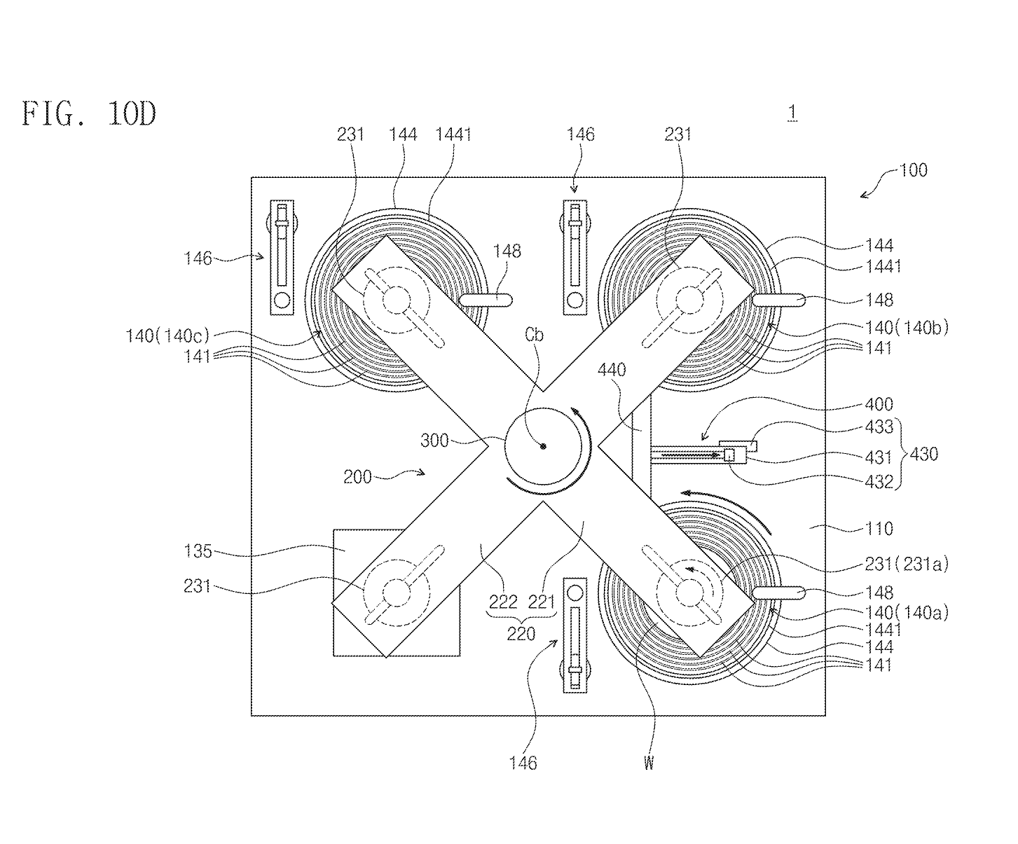

The controller 500 may control the pad conditioner 146 by using profile information I of the polishing pad 140 measured from the polishing pad-measuring apparatus 400. This will be described later in more detail with reference to FIGS. 10A to 10D. In addition, the controller 500 may transmit the profile information I of the polishing pad 140 to the display part 600.

The display part 600 may display the profile information I of the polishing pad 140, transmitted by the controller 500, to a user. The display part 600 may display the profile information I of the polishing pad 140 in a two-dimensional (2D) image form and/or a three-dimensional (3D) image form.

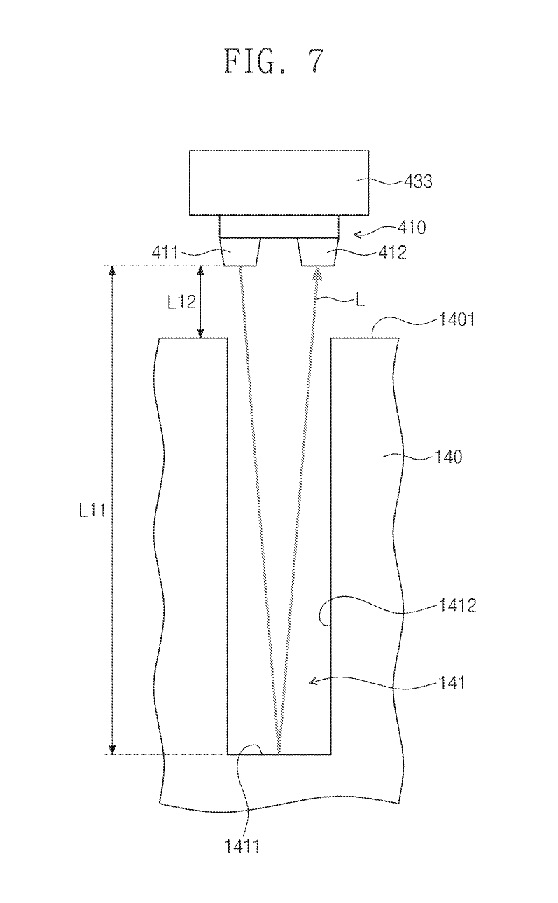

FIGS. 6 and 7 are cross-sectional views illustrating a method of measuring a profile of a polishing pad by the polishing pad-measuring apparatus of FIG. 5, according to some embodiments of the inventive concepts.

Referring to FIGS. 5 to 7, the polishing pad 140 may include one surface 1401 and another surface 1402 opposite to each other. Here, the one surface 1401 may mean a polishing surface for polishing the polishing target surface of a wafer W. Thus, the one surface 1401 may be rough. The another surface 1402 may be in contact with a top surface of the platen 144. The grooves 141 may extend lengthwise from the one surface 1401 toward the another surface 1402 of the polishing pad 140.

Each of the grooves 141 may include a bottom surface 1411 and sidewalls 1412. The sidewalls 1412 may connect the bottom surface 1411 to the one surface 1401 adjacent to the bottom surface 1411. In some embodiments, the sidewalls 1412 may be substantially vertical to the bottom surface 1411.

The foreign material FM may be located in the grooves 141. Thus, the foreign material FM may cover the bottom surface 1411. The foreign material FM may include at least one of slurry or deionized water remaining after the polishing process. However, embodiments of the inventive concepts are not limited thereto. The polishing pad 140 may include a porous material (e.g., polyurethane) having a large number of micro-spaces. The micro-spaces of the polishing pad 140 may receive slurry and/or deionized water used to chemically mechanically polish the polishing target surface of a wafer W.

In some embodiments, the foreign material-removing part 420 may include a blow unit 420 jetting a gas G into the grooves 141. The gas G provided from the blow unit 420 may have weak reactivity to the foreign material FM or may not react with the foreign material FM. For example, the gas G may be a non-reactive gas such as a nitrogen (N₂) gas or an inert gas (e.g., an argon (Ar) gas, a helium (He) gas). However, embodiments of the inventive concepts are not limited thereto.

The blow unit 420 may jet the gas G in a downward slope direction toward a region below the laser sensor 410. For example, a horizontal distance between the blow unit 420 and the center C of the polishing pad 140 may be smaller than a horizontal distance between the laser sensor 410 and the center C of the polishing pad 140. In other words, the blow unit 420 may be disposed between the laser sensor 410 and the center C of the polishing pad 140 when viewed from a plan view. Alternatively, in other example embodiments, the laser sensor 410 may be disposed between blow unit 420 and the center C of the polishing pad 140 when viewed from a plan view. The blow unit 420 may jet the gas G in the downward slope direction from the center C toward the edge E of the polishing pad 140. Thus, the blow unit 420 may remove the foreign material FM disposed in the groove 141 before or while laser L is irradiated to the bottom surface 1411 of the groove 141. Likewise, the blow unit 420 may remove the foreign material FM disposed on the one surface 1401 before or while the laser L is irradiated to the one surface 1401. In some example embodiments, the jet direction of the gas G may form an acute angle with the one surface 1401. However, some example embodiments of the inventive concepts are not limited thereto. In certain example embodiments, the jet direction of the gas G may form a right angle with the one surface 1401.

When the blow unit 420 jets the gas G into the groove 141, the foreign material FM in the groove 141 may be removed by wind pressure of the gas G. In detail, the foreign material FM covering the bottom surface 1411 may fly by the gas G. Thus, the distance measuring part 410 may accurately measure a first distance L11 between the bottom surface 1411 of the groove 111 and the distance measuring part 410.

The distance measuring part 410 may measure a depth D of the groove 141 from which the foreign material FM is removed. In detail, the distance measuring part 410 may measure the first distance L11 between the distance measuring part 410 and the bottom surface 1411 from which the foreign material FM is removed by the foreign material-removing part 420, and a second distance L12 between the distance measuring part 410 and the one surface 1401 of the polishing pad 140. Here, the first distance L11 may mean a vertical distance between the distance measuring part 410 and the bottom surface 1411. In addition, the second distance L12 from the one surface 1401 may mean a vertical distance between the distance measuring part 410 and the one surface 1401.

As described above, the distance measuring part 410 may move along the imaginary linear trajectory LT by the moving unit 430. Thus, the distance measuring part 410 may measure the depths D of the grooves 141 disposed on the imaginary linear trajectory LT. In some example embodiments, the laser sensor 410 (i.e., the distance measuring part 410) may continuously irradiate the laser L to the polishing pad 140 while moving along the imaginary linear trajectory LT. In addition, the blow unit 420 (i.e., the foreign material-removing part 420) may continuously jet the gas G to the polishing pad 140 while moving by the moving unit 430.

The distance measuring part 410 may transmit information I of the first distance L11 and the second distance L12 to the controller 500. Thus, the controller 500 may calculate the depth D of the groove 141 by using the information I of the first distance L11 and the second distance L12. The depth D of the groove 141 may be a difference value between the first distance L11 and the second distance L12. In other words, the depth D of the groove 141 may mean a vertical distance between the bottom surface 1411 and the one surface 1401 adjacent to the bottom surface 1411. In addition, the distance measuring part 410 may measure a width WT of each of the grooves 141. Here, the width WT of the groove 141 may mean a distance between the sidewalk 1412 of the groove 141.

The movement of the distance measuring part 410 and the foreign material-removing part 420 according to some example embodiments will be described hereinafter. The elevating member 433 may reciprocally move along the guide groove 432a, and thus the foreign material-removing part 420 and the distance measuring part 410 coupled to the elevating member 433 may reciprocally move in a direction vertical to the one surface 1401. Thus, the distance measuring part 410 and the foreign material-removing part 420 may move to become close to the one surface 1401 or may move to become far away from the one surface 1401.

In addition, the linear moving member 432 connected to the elevating member 433 may move along the guide member 431, and thus the distance measuring part 410 and the foreign material-removing part 420 may move in parallel to the one surface 1401 of the polishing pad 140. Thus, the distance measuring part 410 may measure the depths D of the grooves 141.

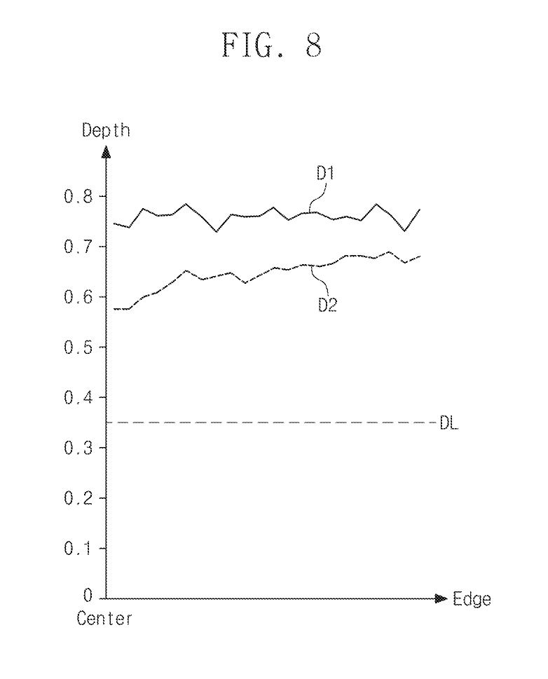

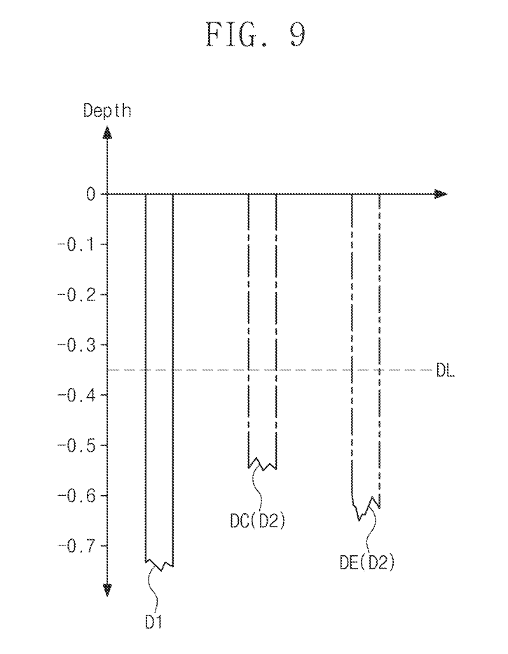

FIGS. 8 and 9 are graphs illustrating the profile of the polishing pad which is measured by the polishing pad-measuring apparatus of FIG. 5. The profile of the polishing pad 140 of FIG. 6 may include the depths D of the grooves 141 of FIG. 6. However, some example embodiments of the inventive concepts are not limited thereto. The reference designator D1 shown in FIGS. 8 and 9 may mean a depth of a groove of a new polishing pad, and the reference designator D2 shown in FIGS. 8 and 9 may mean a depth of a groove of a used polishing pad.

Referring to FIGS. 1 to 9, diurnal variations (e.g., wear) may occur on the polishing pad 140 after the polishing process. Thus, the depths D1 of the grooves of the new polishing pad may be greater than the depths D2 of the grooves of the used polishing pad.

According to some example embodiments of the inventive concepts, more diurnal variations may occur on a central region of the polishing pad 140. Thus, a depth DC of the groove (hereinafter, referred to as ‘a central groove’) adjacent to the center C of the polishing pad 140 may be smaller than a depth DE of the groove (hereinafter, referred to as ‘an edge groove’) adjacent to the edge E of the polishing pad 140. The present inventive concepts are not limited to example embodiments wherein the depth DC is smaller than the depth DE.

The controller 500 may calculate a difference value between the minimum depth and the maximum depth among the depths of the grooves. According to some example embodiments of the inventive concepts, the minimum depth may be the depth DC of the central groove, and the maximum depth may be the depth DE of the edge groove. The present inventive concepts are not limited to example embodiments wherein the minimum depth is DC and the maximum depth is DE.

When the calculated difference value is greater than a set reference value, the controller 500 may control the pad conditioner 146 in such a way that the pad conditioner 146 polishes the one surface 1401 of the polishing pad 140. Since the pad conditioner 146 polishes the one surface 1401, the depth D2 of each of the grooves 141 may correspond to the depth DC of the central groove. Thus, the one surface 1401 of the polishing pad 140 may become substantially flat. The controller 500 may control the pad conditioner 146 in such a way that a polishing time with respect to the one surface 1401 is inversely proportional to a diurnal variation degree (e.g., a wear degree). For example, when the depth DC of the central groove is smaller than the depth DE of the edge groove, the controller 500 may controller the pad conditioner 146 in such a way that a polishing time of a region adjacent to the central groove is shorter than a polishing time of a region adjacent to the edge groove.

The controller 500 may provide a warning message to a user through the display part 600 when a depth of at least one of the grooves 141 is smaller than a limit depth DL. The warning message may be a message for notifying a user of replacement of the polishing pad 140.

A method of operating the chemical mechanical polishing facility 1 according to some example embodiments of the inventive concepts will be described hereinafter.

FIGS. 10A to 10D are plan views illustrating a method of operating the chemical mechanical polishing facility of FIG. 2.

Referring to FIG. 10A, one (hereinafter, referred to as ‘a first polishing head 231a’) of the polishing heads 231 may be disposed over the loading/unloading part 135. The first polishing head 231a may pick up a wafer W disposed on the loading/unloading part 135. In addition, the others of the polishing heads 231 may be disposed over the polishing pads 140, respectively.

The polishing pad-measuring apparatus 400 may be disposed between the loading/unloading part 135 and the polishing pad (hereinafter, referred to as ‘a first polishing pad 140a) adjacent to the loading/unloading part 135 in a rotating direction of the upper body 220. In other words, the polishing pad-measuring apparatus 400 may be spaced apart from the first polishing head 231a by about 45 degrees in a counterclockwise direction on the basis of the center Cb of the upper body 220.

As described above, the upper body 220 may be rotated on its center Cb by the driving apparatus 300. In some example embodiments, the upper body 220 may be rotated in the counterclockwise direction. However, example embodiments of the inventive concepts are not limited thereto.

Referring to FIG. 10B, the upper body 220 may be rotated on its center Cb by about 45 degrees by the driving apparatus 300. Thus, the first polishing head 231a having the wafer W may be disposed between the loading/unloading part 135 and the first polishing pad 140a.

In addition, the polishing pad-measuring apparatus 400 may be disposed over the first polishing pad 140a. At this time, the foreign material-removing part 420 and the distance measuring part 410 may be disposed adjacent to the center C of the first polishing pad 140a. The linear moving member 432 may be moved along the linear guide member 431. In other words, the linear moving member 432 may be moved from the center C toward the edge E of the first polishing pad 140a. Thus, the foreign material-removing part 420 and the distance measuring part 410 may also be moved from the center C toward the edge E of the first polishing pad 140a.

The foreign material-removing part 420 may jet the gas (see G of FIG. 6) into the grooves 141 while moving from the center C toward the edge E of the first polishing pad 140a, thereby removing the foreign material (see FM of FIG. 6) disposed in the grooves 141. The distance measuring part 410 may irradiate the laser (see L of FIG. 6) to the first polishing pad 140a while moving together with the foreign material-removing part 420 from the center C toward the edge E of the first polishing pad 140a, thereby measuring the depth (see D of FIG. 6) of each of the grooves 141.

Referring to FIG. 10C, the controller 500 may control the pad conditioner 146 using the depth information I of the grooves 141 in such a way that the pad conditioner 146 polishes the first polishing pad 140a. Thus, the one surface (see 1401 of FIG. 6) of the first polishing pad 140a may become substantially flat.

Referring to FIG. 10D, the upper body 220 may be rotated on its center Cb by about 45 degrees. Thus, the first polishing head 231a having the wafer W may be disposed on the first polishing pad 140a. In addition, the first polishing pad 140a and the first polishing head 231a may be rotated in a state in which the wafer W and the first polishing pad 140a are in contact with each other.

The polishing pad-measuring apparatus 400 may be disposed between the first polishing pad 140a and another polishing pad 140b (hereinafter, referred to as ‘a second polishing pad 140b) adjacent to the first polishing pad 140a in the rotating direction of the upper body 220. The linear moving member 432 may be moved along the linear guide member 431 in an outward direction of the upper body 220.

The polishing pad-measuring apparatus 400 may be disposed on other polishing pads (i.e., second and third polishing pads 140b and 140c) in consecutive order by the method described with reference to FIGS. 10A to 10D. Thus, the polishing pad-measuring apparatus 400 may measure the depths (see D of FIG. 6) of the grooves 141 of each of the second and third polishing pads 140b and 140c. In other words, the polishing pad-measuring apparatus 400 may be disposed on the polishing pads 140 in consecutive order by the rotation of the polishing head assembly 200 to measure the profiles (e.g., depths) of the grooves 141 of the polishing pad 140. Thus, the chemical mechanical polishing facility 1 may measure the profile of each of the polishing pads 140 by using the polishing pad-measuring apparatus 400.

The first polishing head 231a may be disposed on the second and third polishing pads 140b and 140c in consecutive order. Thus, the wafer W picked up by the first polishing head 231a may be polished by the second and third polishing pads 140b and 140c. Thereafter, the first polishing head 231a may be disposed again on the loading/unloading part 135. Thus, the wafer W sequentially polished by the first to third polishing pads 140a to 140c may be unloaded on the loading/unloading part 135.

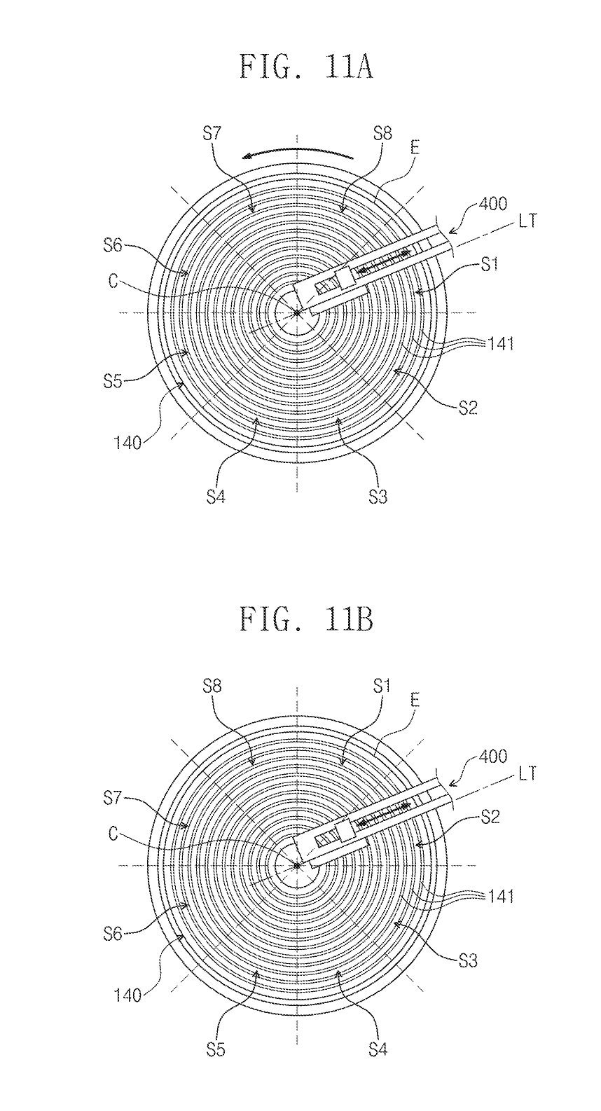

FIGS. 11A and 11B are plan views illustrating another method of measuring a profile of a polishing pad by the polishing pad-measuring apparatus of FIG. 5, according to some example embodiments of the inventive concepts. A measuring method of FIGS. 11A and 11B using the polishing pad-measuring apparatus 400 of FIG. 5 may be different from the measuring method of FIGS. 5 and 6 using the polishing pad-measuring apparatus 400 of FIG. 5.

Referring to FIGS. 5, 6, 11A, and 11B, the one surface 1401 may include scan regions S1 to S8 that are divided at specific angles with respect to the center C of the polishing pad 140. In some example embodiments, the one surface 1401 may include first to eighth scan regions S1 to S8. The first to eighth scan regions S1 to S8 may be divided at angles of 45 degrees with respect to the center C of the polishing pad 140. The first to eighth scan regions S1 to S8 may be sequentially arranged in a counterclockwise direction with respect to the center C of the polishing pad 140.

Referring to FIG. 11A, the linear guide member 431 of the polishing pad-measuring apparatus 400 may be disposed on one of the scan regions S1 to S8. The linear guide member 431 may be disposed in parallel to the imaginary linear trajectory LT connecting the center C and the edge E of the polishing pad 140. The imaginary linear trajectory LT may be disposed in the first scan region S1. Thus, the distance measuring part 410 and the foreign material-removing part 420 may be moved along the imaginary linear trajectory LT to measure the depths of the grooves 141 disposed in the first scan region S1.

Referring to FIG. 11B, the polishing pad 140 may be rotated by a specific angle (e.g., 45 degrees) in the counterclockwise direction after the polishing pad-measuring apparatus 400 measures the depths D of the grooves 141 disposed in the first scan region S1. Here, the rotation angle of the polishing pad 140 may be substantially equal to the angle at which the scan regions S1 to S8 are divided. Thus, the linear guide member 431 may be disposed on the second scan region S2. In other words, the imaginary linear trajectory LT may be disposed in the second scan region S2.

Subsequently, the distance measuring part 410 and the foreign material-removing part 420 may be moved along the imaginary linear trajectory LT to measure the depths of the grooves 141 disposed in the second scan region S2.

The above process may be repeatedly performed to measure the depths of the grooves 141 disposed in the scan regions S1 to S8 by the distance measuring part 410. In other words, the distance measuring part 410 may be disposed on the scan regions S1 to S8 in consecutive order by the rotation of the polishing pad 140 to measure the depths D of the grooves 141 of the scan regions S1 to S8 in consecutive order. Thus, the polishing pad-measuring apparatus 400 may measure the depths of the grooves 141 to display the depths of the grooves 141 in a 3D form. Thus, a user may easily recognize that the depths of the grooves 141 of central and edge regions of the polishing pad 140 are smaller than those of other regions of the polishing pad 140.

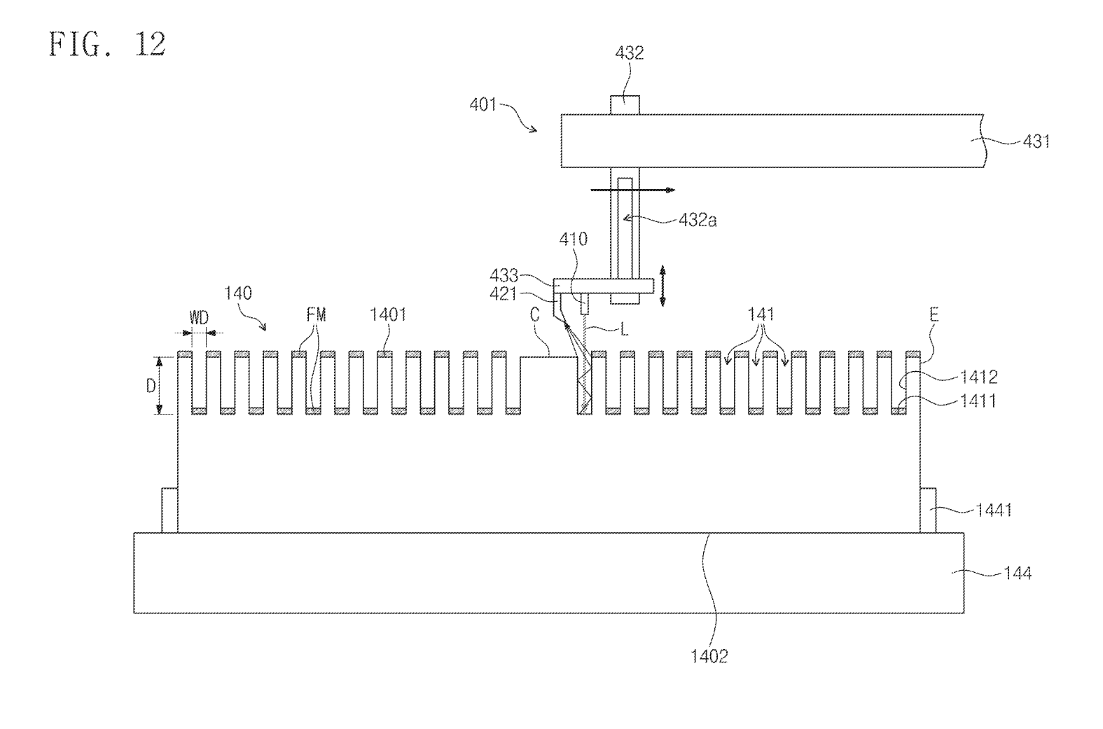

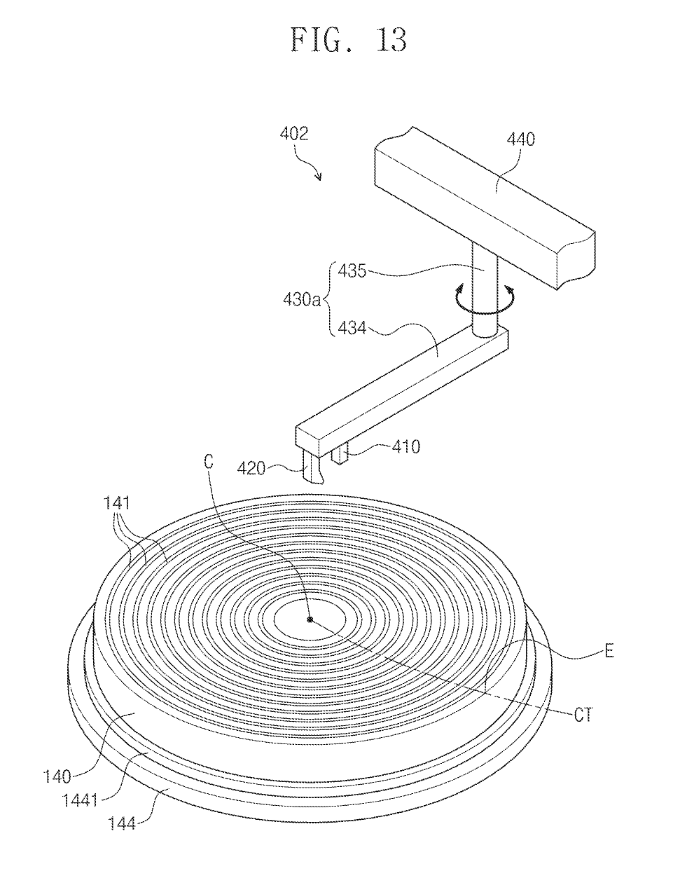

FIG. 12 is a cross-sectional view illustrating a polishing pad-measuring apparatus according to some example embodiments of the inventive concepts.

Referring to FIG. 12, a polishing pad-measuring apparatus 401 according to some example embodiments of the inventive concepts may be provided in a chemical mechanical polishing facility (see 1 of FIG. 1). The polishing pad-measuring apparatus 401 may be similar to the polishing pad-measuring apparatus 400 of FIGS. 5 and 6. Thus, in the present embodiment, the descriptions to the same elements as in the embodiment of FIGS. 5 and 6 will be omitted or mentioned briefly for the purpose of ease and convenience in explanation. In other words, differences between the polishing pad-measuring apparatus 401 and the polishing pad-measuring apparatus 400 of FIGS. 5 and 6 will be mainly described hereinafter. The polishing pad-measuring apparatus 401 according to some example embodiments may remove the foreign material FM by suction, unlike the polishing pad-measuring apparatus 400 of FIG. 6 removing the foreign material FM by the jetting manner.

A foreign material-removing part 421 may include a suction unit for sucking the foreign material FM disposed in the grooves 141. The suction unit 421 may be connected to a pump (not shown) generating a vacuum pressure. The suction unit 421 may suck the foreign material FM through a suction hole.

FIG. 13 is a perspective view illustrating a polishing pad-measuring apparatus according to some example embodiments of the inventive concepts. In the present embodiment, the descriptions to the same technical features as in the embodiment of FIGS. 5 and 6 will be omitted or mentioned briefly for the purpose of ease and convenience in explanation. In other words, differences between the present embodiment and the embodiment of FIGS. 5 and 6 will be mainly described hereinafter.

Referring to FIG. 13, a polishing pad-measuring apparatus 402 according to some example embodiments of the inventive concepts may be provided in a chemical mechanical polishing facility (see 1 of FIG. 1).

The polishing pad-measuring apparatus 402 may include the distance measuring part 410, the foreign material-removing part 420, a moving unit 430a, and the coupling member 440.

The foreign material-removing part 420 may remove the foreign material FM disposed in the grooves 141. In some example embodiments, the foreign material-removing part 420 may be the blow unit 420 blowing the gas G (see FIG. 6) into the groove 141.

The distance measuring part 410 may measure the distance (see L12 of FIG. 7) from the one surface 1401 and the distance (see L11 of FIG. 7) from the bottom surface 1411 of the groove 141 from which the foreign material FM is removed by the foreign material-removing part 421.

The moving unit 430a may include an arm 434 and an arm rotating unit 435.

The arm 434 may have a longish bar shape. A long-directional length (hereinafter, referred to as ‘a length’) of the arm 434 may be equal to or greater than a radius of the polishing pad 140. The distance measuring part 410 and the foreign material-removing part 420 may be connected to one end portion of the arm 434.

The arm rotating unit 435 may connect the coupling member 440 and the arm 434. For example, an upper portion of the arm rotating unit 435 may be coupled to the coupling member 440. A lower portion of the arm rotating unit 435 may be connected to another end portion of the arm 434. The arm rotating unit 435 may rotate the arm 435 by using the another end portion of the arm 434 as a rotation center. Thus, the arm 434 may be moved along a circular arc trajectory CT which is a curved line. The circular arc trajectory CT may pass through the center C and the edge E of the polishing pad 140.

In some example embodiments, the circular arc trajectory CT may pass through one edge E and the center C of the polishing pad 140. Alternatively, the circular arc trajectory CT may pass through both edges E and the center C of the polishing pad 140. Thus, the distance measuring part 410 may measure the first distance (see L11 of FIG. 7) of each of the grooves 141 and the second distance (see L12 of FIG. 7).

In some example embodiments, the arm rotating unit 435 may be disposed in parallel to a direction vertical to the one surface 1401 of the polishing pad 140. In addition, the arm 434 may be movable along the arm rotating unit 435 in the direction vertical to the one surface 1401 of the polishing pad 140. In other words, the arm 434 may be movable along the arm rotating unit in a longitudinal direction

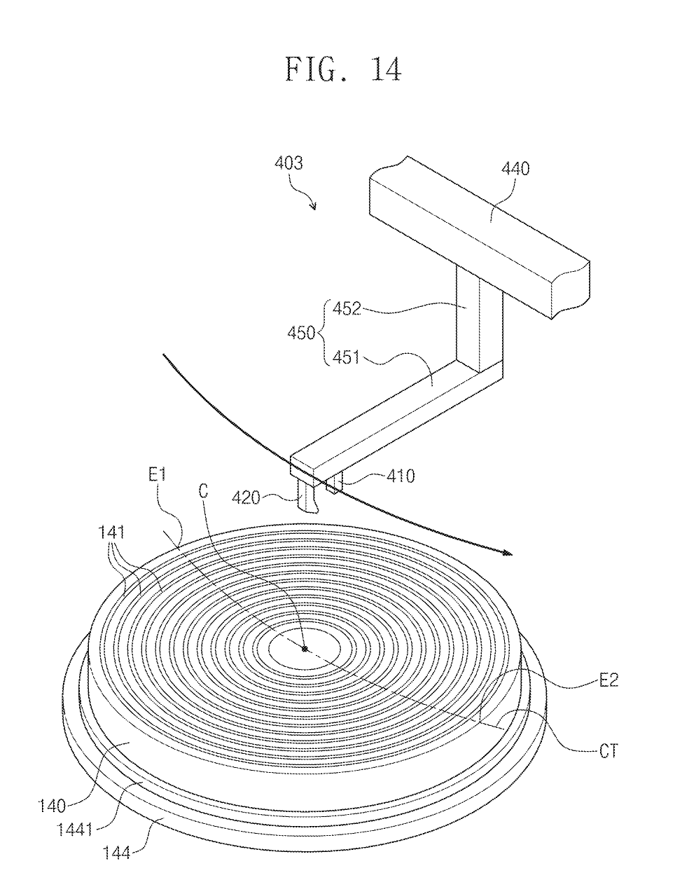

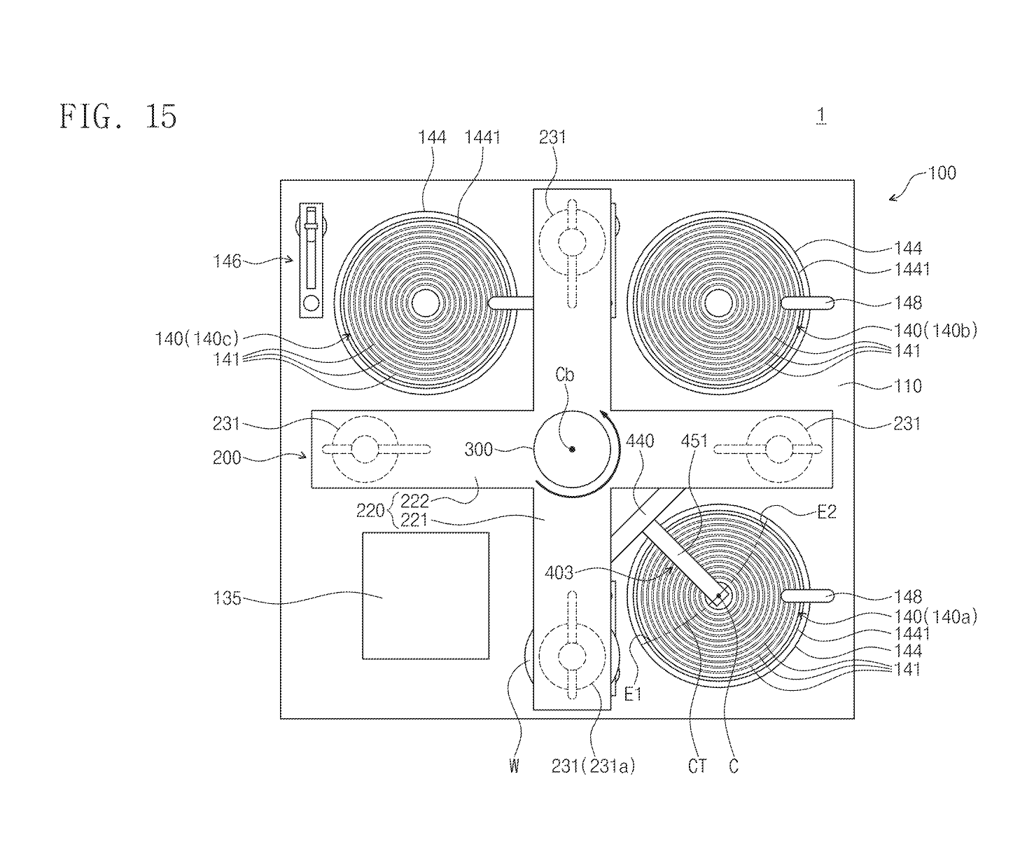

FIG. 14 is a perspective view illustrating a polishing pad-measuring apparatus according to some example embodiments of the inventive concepts. FIG. 15 is a plan view illustrating a method of measuring a profile of a polishing pad by the polishing pad-measuring apparatus of FIG. 14, according to some example embodiments of the inventive concepts. In the present embodiment, the descriptions to the same technical features as in the embodiment of FIGS. 5 and 6 will be omitted or mentioned briefly for the purpose of ease and convenience in explanation. In other words, differences between the present embodiment and the embodiment of FIGS. 5 and 6 will be mainly described hereinafter.

Referring to FIGS. 14 and 15, a chemical mechanical polishing facility 1 may be the same or similar as the chemical mechanical polishing facility 1 of FIGS. 1 to 4. The chemical mechanical polishing facility 1 may include the polishing station 100, the polishing head assembly 200, the driving apparatus 300, a polishing pad-measuring apparatus 403, the controller 500 of FIG. 1, and the display part 600 of FIG. 1.

The polishing pad-measuring apparatus 403 may include the distance measuring part 410, the foreign material-removing part 420, a connection member 450, and the coupling member 440.

The connection member 450 may include a first connection portion 451 and a second connection portion 452.

The first connection portion 451 may be coupled to the distance measuring part 410 and the foreign material-removing part 420. For example, the distance measuring part 410 and the foreign material-removing part 420 may be coupled to one end portion of the first connection portion 451. The first connection portion 451 may be disposed in parallel to the one surface (Reference to 1401 in FIG. 6) of the polishing pad 140.

The second connection portion 452 may connect the first connection portion 451 to the coupling member 440. For example, the second connection portion 452 may extend from another end portion of the first connection portion 451 to the coupling member 440. The second connection portion 452 may be disposed in parallel to a direction vertical to the one surface 1401 of the polishing pad 140.

The polishing pad-measuring apparatus 403 according to the present embodiment may not include a moving unit (see 430 of FIG. 1) moving the distance measuring part 410 and the foreign material-removing part 420, unlike the polishing pad-measuring apparatus 400 of FIG. 1.

A method of measuring a profile of the polishing pad 140 by the polishing pad-measuring apparatus 403 will be described hereinafter.

One (hereinafter, referred to as ‘a first polishing head 231a’) of the polishing heads 231 may pick up a wafer W of the loading/unloading part 135. The polishing pad-measuring apparatus 403 may be disposed between the loading/unloading part 135 and the polishing pad (hereinafter, referred to as ‘a first polishing pad 140a) adjacent to the loading/unloading part 135 in a rotating direction of the upper body 220. In other words, the polishing pad-measuring apparatus 403 may be spaced apart from the first polishing head 231a by about 45 degrees in a counterclockwise direction on the basis of the center Cb of the upper body 220.

The upper body 220 may be rotated on its center Cb by the driving apparatus 300. In some example embodiments, the upper body 220 may be rotated by about 90 degrees in the counterclockwise direction. Thus, the first polishing head 231a may be located on the first polishing pad 140a, and then, the wafer W may be polished by the first polishing head 231a and the first polishing pad 140a.

The distance measuring part 410 and the foreign material-removing part 420 of the polishing pad-measuring apparatus 403 may be horizontally moved along a scan trajectory CT on the first polishing pad 140a during the rotation of the upper body 220. Here, the scan trajectory CT may be a curved line that passes through a left edge E1 of the first polishing pad 140a, the center C of the first polishing pad 140a, and a right edge E2 of the first polishing pad 140b opposite to the left edge E1. The center C may be disposed between the left edge E1 and the right edge E2 on the scan trajectory CT.

The polishing pad-measuring apparatus 403 may measure the depths of the grooves 141 without an additional element moving the distance measuring part 410 and the foreign material-removing part 420. The polishing pad-measuring apparatus 403 may measure depths of the grooves 141 of other polishing pads 140 by this method.

According to some example embodiments of the inventive concepts, the profile (e.g., the depths of the grooves) of the polishing pad may be accurately measured. Thus, a target surface of a wafer may be precisely polished using the polishing pad. In addition, a lifetime of the polishing pad may be measured to accurately determine whether the polishing pad is replaced with a new one or not.

While the inventive concepts have been described with reference to example embodiments, it will be apparent to those skilled in the art that various changes and modifications may be made without departing from the spirits and scopes of the inventive concepts. Therefore, it should be understood that the above example embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A polishing pad-measuring apparatus configured to measure a profile of a polishing pad polishing a wafer, the polishing pad-measuring apparatus comprising:
a foreign material-removing part configured to remove a foreign material disposed in a plurality of grooves, the grooves extending from a first surface of the polishing pad toward a second surface, opposite to the first surface, of the polishing pad; and
a distance measuring part configured to measure depths of the grooves from which the foreign material-removing part has removed the foreign material.

2. The polishing pad-measuring apparatus of claim 1, wherein the foreign material-removing part includes a blow unit configured to jet a gas into the grooves.

3. The polishing pad-measuring apparatus of claim 2, wherein the gas includes a non-reactive gas.

4. The polishing pad-measuring apparatus of claim 1, wherein the foreign material-removing part includes a suction unit configured to suck the foreign material disposed in the grooves.

5. The polishing pad-measuring apparatus of claim 1, wherein the grooves are arranged at equal intervals from a center of the polishing pad toward an edge of the polishing pad, the polishing pad-measuring apparatus further comprising:
a moving unit for moving the distance measuring part along a trajectory connecting the center and the edge of the polishing pad,
wherein the moving unit is configured to move the foreign material-removing part along the trajectory, and
wherein the moving unit is configured to move the distance measuring part together with the distance measuring along the trajectory.

6. The polishing pad-measuring apparatus of claim 1, further comprising:
a moving unit, wherein the moving unit includes;
a linear guide member,
a linear moving member moving along the linear guide member, and
an elevating member moving along the linear moving member,
and wherein the distance measuring part and the foreign material-removing part are coupled to the elevating member.

7. The polishing pad-measuring apparatus of claim 1, further comprising:
a moving unit, the moving unit including;
an arm connected to the distance measuring part and the foreign material-removing part, and
an arm rotating unit configured to rotate the arm to move the distance measuring part along the trajectory.

8. The polishing pad-measuring apparatus of claim 7, wherein the trajectory is a linear line or a curved line.

9. The polishing pad-measuring apparatus of claim 1, wherein the polishing pad includes a plurality of scan regions divided at equal angles with respect to the center of the polishing pad, and
wherein the distance measuring part is disposed on the imaginary scan regions in consecutive order by rotation of the polishing pad.

10. The polishing pad-measuring apparatus of claim 1, wherein the depth of each of the grooves is calculated using a first distance between the distance measuring part and a bottom surface of each of the grooves and a second distance between the distance measuring part and the one surface of the polishing pad, and
wherein the first distance and the second distance are obtained by the distance measuring part.

11. The polishing pad-measuring apparatus of claim 1, wherein the distance measuring part includes a laser sensor.

12. A chemical mechanical polishing facility comprising:
a polishing station including a plurality of platens and polishing pads respectively disposed on the platens;
a rotatable polishing head assembly disposed on the polishing station, the polishing head assembly including a plurality of polishing heads, the plurality of polishing heads configured to pick up a wafer; and
a polishing pad-measuring apparatus coupled to the polishing head assembly,
wherein each of the polishing pads has a plurality of grooves extending from one surface toward another surface opposite to the one surface, and
wherein the polishing pad-measuring apparatus includes,
a foreign material-removing part configured to remove at least one foreign material disposed in the grooves, and
a distance measuring part configured to measure depths of the grooves from which the foreign material-removing part has removed foreign material.

13. The chemical mechanical polishing facility of claim 12, wherein the polishing pad-measuring apparatus is disposed on the polishing pads in consecutive order by rotation of the polishing head assembly.

14. The chemical mechanical polishing facility of claim 12, wherein the foreign material-removing part includes a blow unit configured to jet a gas into the grooves.

15. The chemical mechanical polishing facility of claim 12, wherein the polishing head assembly further comprises:
an upper body including a first bar part and a second bar part intersecting the first bar part,
wherein the polishing heads are disposed adjacent to both ends of the first bar part and both ends of the second bar part, respectively, and
wherein the polishing pad-measuring apparatus is disposed in a space between the first bar part and the second bar part.

16. A chemical mechanical polishing facility comprising:
a polishing station including a pad conditioner configured to condition a polishing pad;
a polishing pad measuring apparatus including a foreign material-removing part and a distance measuring part, the foreign material-removing part being configured to remove at least one foreign material disposed in a plurality of grooves of the polishing pad, and the distance measuring part being configured to measure depths of the grooves of the polishing pad from which the foreign material-removing part has removed foreign material; and
a controller configured to control the pad conditioner based on output from the distance measuring part.

17. The chemical mechanical polishing facility of claim 16, wherein
the controller is configured to calculate a first time based on the output from the distance measuring part;
the controller is configured to calculate a second time based on the output from the distance measuring part;
the controller is configured to control the pad conditioner such that the pad conditioner conditions a first region of the polishing pad for the first time; and
the controller is configured to control the pad conditioner such that the pad conditioner conditions a second region of the polishing pad for the second time.

18. The chemical mechanical polishing facility of claim 16, wherein
the distance measuring part is configured to obtain a first distance between the distance measuring part and a bottom surface of each of the grooves, and is configured to obtain a second distance between the distance measuring part and a top surface of the polishing pad, and
the controller is configured to calculate the depth of each of the grooves using the first distance and the second distance.

19. The chemical mechanical polishing facility of claim 16, further comprising:
a display part, wherein
the display part is configured to display profile information of the polishing pad,
wherein the profile information indicates the depths of the grooves of the polishing pad.

20. The chemical mechanical polishing facility of claim 16, further comprising:
a display part, wherein
the display part is configured to display a warning message when a depth of at least one of the grooves is smaller than a limit depth.
